(19) United States
(12) Patent Application Publication
(10) Pub. No.: US 2017/0224453 A1
(43) Pub. Date: Aug. 10, 2017

(54) METHOD AND APPARATUS FOR BIOFILM DISINFECTION

(71) Applicant: KONINKLIJKE PHILIPS N.V., EINDHOVEN (NL)

(72) Inventor: BART GOTTENBOS, BUDEL (NL)

(21) Appl. No.: 15/328,624

(22) PCT Filed: Jul. 13, 2015
(86) PCT No.: PCT/IB2015/055274

§ 371 Date: Jan. 24, 2017

Related U.S. Application Data
(60) Provisional application No. 62/030,688, filed on Jul. 30, 2014.

(51) Int. Cl. A61C 17/02; A61C 17/022; A61C 1/00

(52) U.S. Cl. CPC A61C 17/0217; A61C 17/0202; A61C 1/0015; A61C 1/0092; A61C 17/022

(57) ABSTRACT

A method (30) for disinfection of a biofilm layer comprises thinning (34) the biofilm layer from an initial thickness to below a given thickness. The method further includes actively drying (36) the thinned biofilm layer for a predetermined active drying interval to disinfect and remove a substantial portion of the body of biofilm bacteria of the thinned biofilm layer. A device (50) for disinfection of a biofilm layer is configured for implementing the method.

This application claims the benefit or priority of and describes relationships between the following applications: wherein this application claims the priority of U.S. Provisional Patent Application Ser. No. 62/030,688, filed Jul. 30, 2014, which is incorporated herein in whole by reference.

The present embodiments relate generally to biofilm removal and more particularly, to a method and apparatus for biofilm disinfection.

Microbial biofilms present a number of problems. Specifically, in an oral cavity, dental plaque biofilm on a subject's teeth is a significant factor responsible for causing oral disease. In an effort to minimize and/or prevent an occurrence of oral disease, oral hygiene is needed to remove a majority of the dental plaque. However, removal of the majority of dental plaque alone is insufficient.

After oral hygiene, i.e., by brushing a subject's teeth and/or flossing between the teeth, thinner layers of dental plaque remain. These thinner layers of remaining dental plaque, however, quickly grow back to thicker layers.

Accordingly, a method and apparatus is needed for disinfecting the remaining thinner plaque layers, to keep the teeth clean for a longer time after oral hygiene. In addition, there is needed a method and apparatus for disinfecting the remaining thinner plaque layers without using antimicrobial agents. An improved method and apparatus for overcoming the problems in the art is thus desired.

As noted herein, after oral hygiene, many dental plaque bacteria stay behind on the teeth. It has been discovered that the dental plaque bacteria that stay behind after oral hygiene can be easily disinfected using an active drying step, provided that the remaining dental plaque layer is thin enough. According to one embodiment of the present disclosure, a method for disinfection of a biofilm layer comprises a cleaning step followed by a drying step to remove and kill a main body of biofilm bacteria. In another embodiment, a biofilm removal device is provided which thins down the biofilm layer with combination of liquid and air spray, and subsequently delivers a number of air pulses alone, without liquid, for a predetermined duration to actively dry, and thus disinfect, a thinned biofilm plaque layer.

In accordance with one aspect, a method for disinfection of a biofilm layer comprises: thinning the biofilm layer from an initial thickness to below a threshold thickness to produce a thinned biofilm layer, wherein the thinned biofilm layer includes a body of biofilm bacteria; and actively drying the thinned biofilm layer for a predetermined active drying interval to disinfect and remove a substantial portion of the body of biofilm bacteria of the thinned biofilm layer. In another aspect, the biofilm layer comprises an oral biofilm and the threshold thickness comprises twenty micrometers. In one embodiment, the predetermined active drying interval comprises a time interval less than two seconds, and more preferably, the predetermined active drying interval further comprises a time interval less than one second.

In accordance with another aspect, actively drying the thinned biofilm layer comprises administering at least one selected from the group comprising (i) air flow, (ii) hot air flow, (iii) air flow plus external heating, and (iv) strong water absorbing materials onto the thinned biofilm layer for the predetermined active drying interval to disinfect and remove the substantial portion of the body of biofilm bacteria of the thinned biofilm layer. In addition, in another embodiment, the air flow comprises a plurality of air pulses, and further wherein the hot air flow comprises a plurality of warm air pulses having a temperature greater than a threshold temperature.

In accordance with another aspect, the method includes wherein thinning the biofilm layer from the initial thickness to below the threshold thickness comprises pumping a fluid via at least one channel to at least one orifice directed at the biofilm layer, wherein the orifice expels the fluid as of a jet, a spray, or any combination thereof. In one embodiment, pumping the fluid comprises pumping via a microburst pump.

In accordance with yet another aspect, a device for disinfection of a biofilm layer, comprises: a nozzle having an elongated body with at least one channel extending from a proximal end of the nozzle to a distal end of the nozzle, and a tip at the distal end of the nozzle having at least one orifice coupled to the at least one channel; a handle having a proximal end and a distal end, wherein the proximal end of the nozzle removably couples to the distal end of the handle; an activation button operable between an OFF state and at least one activation ON state; a fluid reservoir for holding a fluid; a microburst pump coupled between the fluid reservoir and the at least one channel, the at least one channel being coupled to an orifice; and an active dryer coupled to the at least one channel, coupled to an orifice, wherein responsive to directing the tip towards the biofilm layer and disposing the activation button to the at least one activation ON state, (i) the microburst pump is operable to pump the fluid via the first channel to the first orifice and the first orifice expels the fluid as one of a jet, a spray, or any combination thereof, to thin the biofilm layer from an initial thickness to below a threshold thickness to produce a thinned biofilm layer, and (ii) the active dryer is operable, subsequent to producing the thinned biofilm layer via the microburst pump, to administer at least one of air and a strong water absorbing material via the at least one channel to an orifice to actively dry the thinned biofilm layer for a predetermined active drying interval to disinfect the thinned biofilm layer.

In another embodiment, the biofilm layer comprises an oral biofilm and the threshold thickness comprises twenty micrometers. In one embodiment, the predetermined active drying interval comprises a time interval less than two seconds, and more preferably, the predetermined active drying interval further comprises a time interval less than one second.

According to one aspect, the device includes administering at least one of air and a strong water absorbing material via the second channel to the second orifice to actively dry the thinned biofilm layer that comprises administering at least one selected from the group comprising (i) air flow, (ii) hot air flow, (iii) air flow plus external heating, and (iv) strong water absorbing materials onto the thinned biofilm layer for the predetermined active drying interval to disinfect and remove the substantial portion of the body of biofilm bacteria of the thinned biofilm layer. The device further includes wherein the air flow comprises a plurality of air pulses, and further wherein the hot air flow comprises a plurality of warm air pulses having a temperature greater than a threshold temperature.

According to yet another aspect, the device includes wherein the first orifice and the second orifice comprise one selected from the group consisting of (i) a singular orifice wherein the first channel and the second channel merge into a single channel coupled to the singular orifice, and (ii) separate distinct orifices. The device further includes wherein the separate distinct orifices comprise one selected from the group consisting of (a) orifices spaced laterally from one another and (b) orifices arranged in a coaxial configuration, with one of the first or second orifices being positioned in a central location and the other of the first or second orifices being positioned around the central location.

The embodiments of the present disclosure advantageously solve the problem of keeping a subject's teeth clean for a longer time after oral hygiene by disinfecting dental plaque, and significantly delaying and/or preventing the dental plaque from quickly growing back to thicker layers.

Another advantage resides in thinning of the biofilm layers and disinfecting remaining thinner biofilm layers, to keep the teeth clean for a longer time after oral hygiene, compared with prior techniques. In addition, the embodiments of the present disclosure advantageously provide a method and apparatus for disinfecting the remaining thinner plaque layers without using antimicrobial agents.

Still further advantages and benefits will become apparent to those of ordinary skill in the art upon reading and understanding the following detailed description.

The embodiments of the present disclosure may take form in various components and arrangements of components, and in various steps and arrangements of steps. Accordingly, the drawings are for purposes of illustrating the various embodiments and are not to be construed as limiting the embodiments. In the drawing figures, like reference numerals refer to like elements. In addition, it is to be noted that the figures may not be drawn to scale.

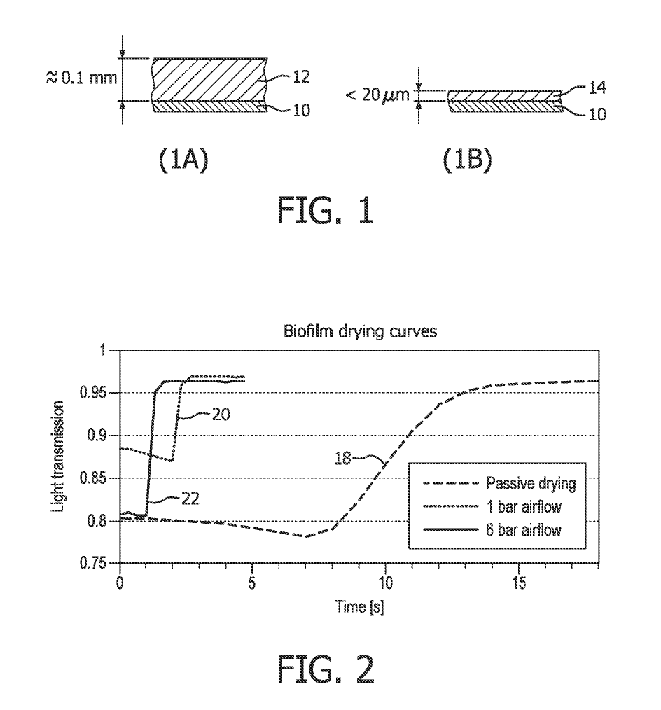

FIGS. 1(A) and 1(B) comprise two cross sections of a dental plaque biofilm layer are shown, before and after treatment, according to an embodiment of the present disclosure;

FIG. 2 is a graph view of a plot of biofilm drying curves for 0.1 mm thick biofilms subjected to different continuous air flows according to an embodiment of the present disclosure;

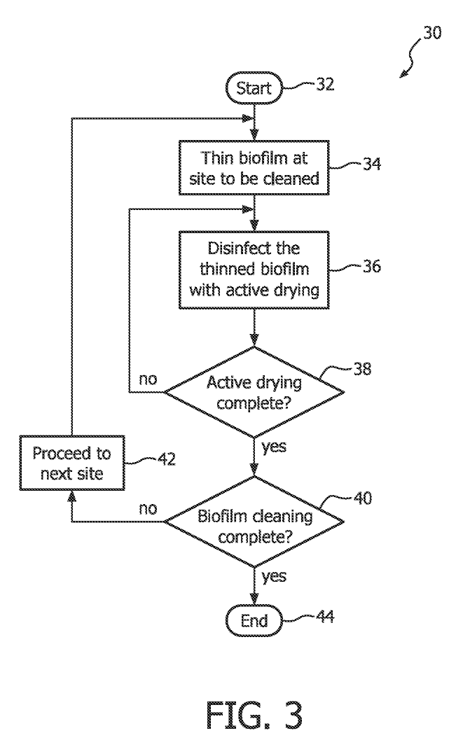

FIG. 3 is a flow diagram view of a method for disinfection of a biofilm layer in a biofilm disinfection procedure for a given subject's teeth, according to an embodiment of the present disclosure;

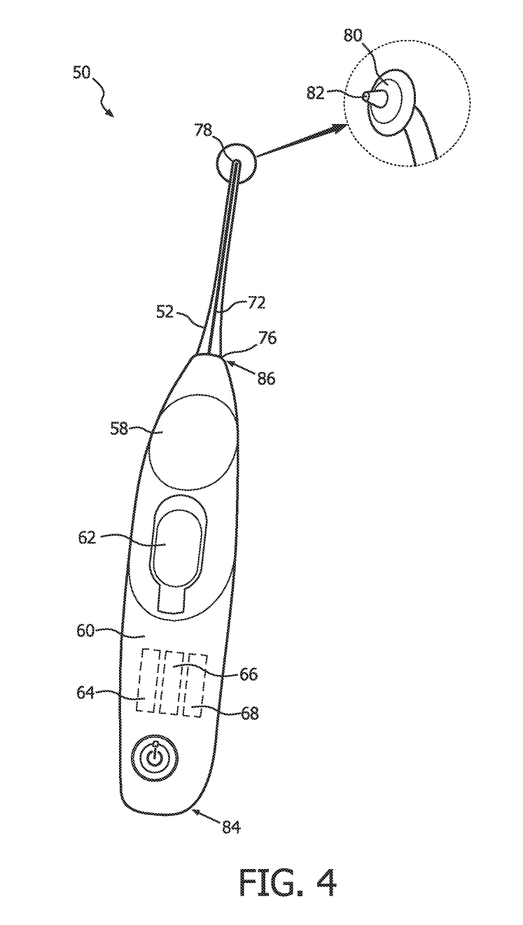

FIG. 4 is a perspective view of a device for disinfection of a biofilm layer for implementing a biofilm disinfection procedure according to an embodiment of the present disclosure;

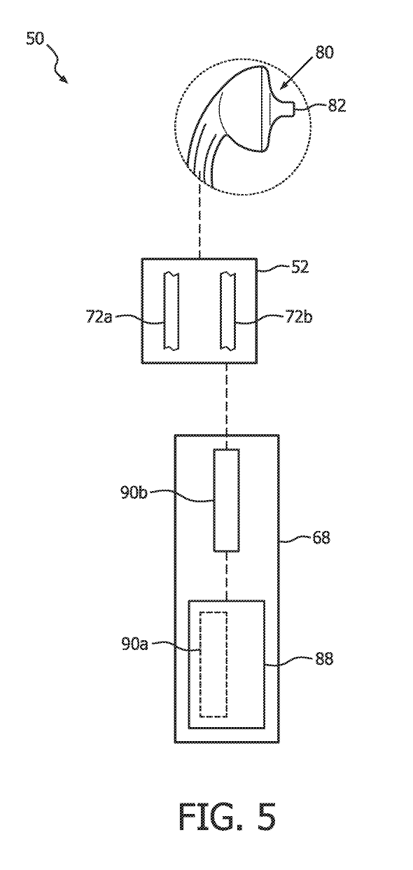

FIG. 5 is a schematic view of various components of the device for disinfection of a biofilm layer for implementing a biofilm disinfection procedure according to an embodiment of the present disclosure; and

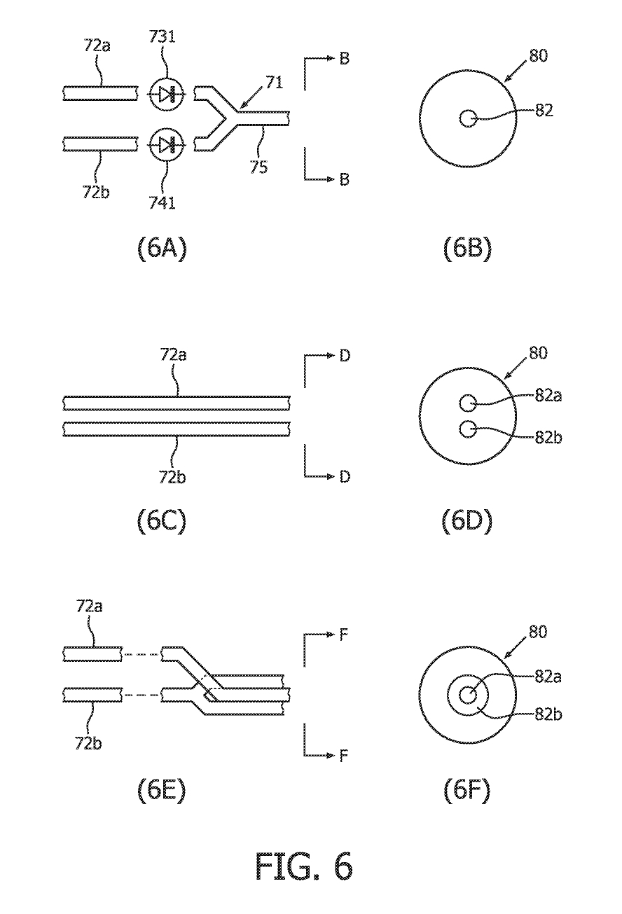

FIGS. 6 (6(A), 6(B), 6(C), 6(D), 6(E), and 6(F)) illustrates side cross-sectional views and sectional views of first, second, and third alternate embodiments of a nozzle of the device for disinfection of a biofilm layer, according to additional embodiments of the present disclosure.

The embodiments of the present disclosure and the various features and advantageous details thereof are explained more fully with reference to the non-limiting examples that are described and/or illustrated in the drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the present disclosure. The examples used herein are intended merely to facilitate an understanding of ways in which the embodiments of the present may be practiced and to further enable those of skill in the art to practice the same. Accordingly, the examples herein should not be construed as limiting the scope of the embodiments of the present disclosure, which is defined solely by the appended claims and applicable law.

It is understood that the embodiments of the present disclosure are not limited to the particular methodology, protocols, devices, apparatus, materials, applications, etc., described herein, as these may vary. It is also to be understood that the terminology used herein is used for the purpose of describing particular embodiments only, and is not intended to be limiting in scope of the embodiments as claimed. It must be noted that as used herein and in the appended claims, the singular forms “a,” “an,” and “the” include plural reference unless the context clearly dictates otherwise.

Unless defined otherwise, all technical and scientific terms used herein have the same meanings as commonly understood by one of ordinary skill in the art to which the embodiments of the present disclosure belong. Preferred methods, devices, and materials are described, although any methods and materials similar or equivalent to those described herein can be used in the practice or testing of the embodiments.

As noted herein, after oral hygiene, many dental plaque bacteria stay behind on the teeth. The inventor has discovered that the dental plaque bacteria that stay behind after oral hygiene can be easily disinfected using an active drying step, provided that the remaining dental plaque layer subsequent the oral hygiene is thin enough. According to one embodiment of the present disclosure, a method for disinfection of a biofilm layer comprises a cleaning step followed by a drying step to remove and kill a main body of biofilm bacteria. In another embodiment, a biofilm removal device is provided which thins down an interproximal plaque layer with a microburst combination of liquid and air spray, and subsequently delivers a number of air pulses alone, without liquid, for a predetermined duration to actively dry the thinned plaque layer.

It has been discovered that thin, but not thick, biofilm layers can be largely disinfected by drying. The present invention includes a combination of a mechanical biofilm removal step, such as, via fluid assisted removal of the biofilm that leaves only a thin biofilm layer behind, and immediately followed by a subsequent active drying step.

According to embodiments of the present disclosure, a method and device for disinfection of a biofilm layer include a cleaning cycle and a drying cycle. During cleaning, the biofilm layer is first thinned down to less than a threshold thickness. For example, for an oral biofilm, the threshold thickness comprises a thickness of less than twenty micrometers (<20 μm). The initial thinning of the biofilm layer can be achieved, for example, by brushes, water jets, spray jets, ultrasonic cleaning, rubbing action, polishing action, etc. In one embodiment, the device for disinfection of a biofilm layer uses fluid forces to thin down dental plaque to less than the threshold thickness.

With reference now to FIGS. 1(A) and 1(B), two cross sections of a biofilm plaque layer on a dental surface, surface 10, before and after treatment, respectively, are shown. The main part of the plaque 12 shown in FIG. 1(A), a layer approximately 0.1 mm thick in this embodiment, was removed, leaving only a thin biofilm layer 14, preferably less than 20 micrometers in thickness, behind as shown in FIG. 1(B).

To ensure full drying, an active drying process is needed in applications where time is critical, such as in oral hygiene. The active drying process comprises providing one or more of an air flow, hot air flow (e.g., via a blow dryer), air flow plus external heating (e.g., air flow and the use of infra-red light), and/or using strong water absorbing materials. The active drying process will be discussed further herein below, with reference to FIGS. 3-6.

With reference now to FIG. 2, a plot of biofilm drying curves for 0.1 mm thick biofilms, when subjected to different continuous air flows, is shown. The plot comprises percentage light transmission of the biofilms being dried versus time in seconds for three different continuous airflows. A measure of percentage light transmission was used, since dry biofilms have higher light transmission than non-dry biofilms. In addition, the three different continuous airflows included (i) passive airflow, (ii) 1 bar airflow, and (iii) 6 bar airflow. While passive drying (i.e., indicated by curve 18) takes approximately fifteen seconds (15 s), active air flow drying (i.e., 1 bar airflow, indicated by curve 20) can shorten drying times to less than approximately two seconds (<2 s). With higher active airflow (i.e., 6 bar airflow, indicated by curve 22), drying can be achieved in less than approximately one second (<1 s).

With reference now to FIG. 3, a flow diagram of a method 30 for disinfection of a biofilm layer according to one embodiment of the present disclosure, is illustrated. The method 30 begins at step 32, for example, by activation of a start button or icon on a device. The next step includes a cleaning step for thinning the biofilm at a site (step 34), for example, using one or more of the methods for thinning discussed herein. Cleaning the biofilm layer includes thinning the layer from an initial thickness to below a threshold thickness (such as, for example, with oral biofilm, less than 20 micrometers). In other words, cleaning produces the thinned biofilm layer having a thickness that is below the desired threshold thickness.

Subsequent to thinning the biofilm, and within a predetermined time after the cleaning step, the method includes disinfecting the thinned biofilm with active drying (step 36). For example, active drying can include using one or more of the methods for active drying discussed herein. The step of actively drying the remaining thinned biofilm layer for a predetermined active drying interval advantageously disinfects the thinned biofilm layer, as discussed herein.

In a next step, a query (step 38) determines whether or not the active drying is complete. The query can include any suitable query, as determined according to the requirements for a given implementation of the disinfection of a biofilm layer. For example, the query may include monitoring a timed duration of the active drying, and indicating non-completion or completion based upon whether or not an expiration of the timed duration of the active drying has occurred. The query could also include whether or not a predetermined number of air bursts in a continuous stream of air bursts have been delivered. Other query criteria are also possible. In response to active drying not being complete, the method continues with (or repeats) disinfecting the thinned biofilm with active drying (step 36). On the other hand, in response to the active drying being complete, the method continues to step 40.

In step 40, a query determines whether or not an overall biofilm cleaning for a given disinfection procedure for a subject's teeth is complete. In response to the overall procedure not being complete, the method proceeds to a next site to be cleaned in the biofilm disinfection procedure (step 42). After step 42, the method continues with (or repeats), beginning again at step 34, with thinning of the biofilm at the next site to be cleaned. On the other hand, in step 40, in response to the overall biofilm cleaning, disinfection procedure being complete, the method terminates at step 44. The step 40 decision to continue or to terminate may be controlled in a variety of ways. The user simply turning the device off is one way. An automatic termination after a set number of cycles is another way.

According to one embodiment, a method for disinfection of a biofilm layer, comprises: thinning the biofilm layer from an initial thickness to below a threshold thickness to produce a thinned biofilm layer, wherein the thinned biofilm layer includes a body of biofilm bacteria; and actively drying the thinned biofilm layer for a predetermined active drying interval to disinfect and remove a substantial portion of the body of biofilm bacteria of the thinned biofilm layer. In one embodiment, the biofilm layer comprises an oral biofilm and the threshold thickness comprises twenty micrometers. The predetermined active drying interval comprises a time interval less than two seconds, and more preferably, the predetermined active drying interval further comprises a time interval less than one second.

In another embodiment, actively drying the thinned biofilm layer comprises administering at least one selected from the group comprising (i) air flow, (ii) warm air flow, (iii) air flow plus external heating, and (iv) strong water absorbing materials onto the thinned biofilm layer for the predetermined active drying interval to disinfect and remove the substantial portion of the body of biofilm bacteria of the thinned biofilm layer. In another embodiment, the air flow comprises a plurality of air pulses, and further wherein the hot air flow comprises a plurality of warm air pulses having a temperature greater than a threshold temperature. For example, the threshold temperature can comprise a temperature greater than ambient temperature sufficient to accelerate the disinfecting process. Preferably, the threshold temperature comprises a temperature in a range of 37° C. to about 50° C., which may be perceived as warm and bearable. Above 50° C. will likely be experienced by a user as being too hot.

In yet another embodiment, thinning the biofilm layer from the initial thickness to below the threshold thickness comprises pumping a fluid via a channel to an orifice directed at the biofilm layer, wherein the orifice expels the fluid as one of a jet, a spray, or any combination thereof. In one embodiment, pumping the fluid comprises pumping via a microburst pump.

In yet another embodiment, the method includes using, during thinning and actively drying, a first orifice and a second orifice that comprise one selected from the group consisting of (i) a singular orifice wherein the first channel and the second channel merge into a single channel coupled to the singular orifice, and (ii) separate distinct orifices. Still further, the method includes using separate distinct orifices that comprise one selected from the group consisting of (a) orifices spaced laterally from one another and (b) orifices arranged in a coaxial configuration, with one of the first or second orifices being positioned in a central location and the other of the first or second orifices being positioned around the central location.

With reference now to FIG. 4, a perspective view of a device 50 for implementing a biofilm disinfection procedure including a user replaceable nozzle 52 according to an embodiment of the present disclosure is shown. Device 50 for disinfection of a biofilm layer further includes an activation button 58, an ergonomic handle 60, a water reservoir 62, control electronics 64, a microburst pump 66, and an active dryer 68. The user replaceable nozzle 52 has at least one channel 72 extending from a proximal end 76 of the nozzle to a distal end 78 of the nozzle. A tip 80 is provided at the distal end of the nozzle 78 having at least one orifice 82 coupled to the at least one channel 72 disposed within the nozzle 52. Handle 60 has a proximal end 84 and a distal end 86. The proximal end 76 of the nozzle 52 removably couples to the distal end 86 of the handle 60. Responsive to coupling of the proximal end 76 of nozzle 52 to the distal end 86 of the handle 60, an appropriate connection between the fluid reservoir 62 and the at least one orifice 82, via the at least one channel 72, are made for a given implementation.

In one embodiment, activation button 58 is operable between an OFF state and at least one activation ON state. The at least one activation ON state can comprise one or more states for causing (b)(i) the microburst pump 66 to be operable to pump fluid from the reservoir 62 to the at least one orifice 82 via the at least one channel 72 and (b)(ii) the active dryer 68 to be operable to administer air via the at least one channel 72 to the at least one orifice 82 to actively dry the thinned biofilm layer for a predetermined active drying interval, as discussed further herein.

Turning now to FIG. 5, a schematic view of various components of the device 50 for disinfection of a biofilm layer according to an embodiment of the present disclosure is shown. In particular, the active dryer 68 includes any suitable air source 88 and one or more of aa heater 90, either internal to the air source 90a or external to the air source 90b. Air source 88 may comprise any suitable continuous air pumps, optionally with a heating element to elevate temperatures. In one embodiment, administering air from air source 88, via the second channel 72b, to the at least one orifice 82 to actively dry the thinned biofilm layer comprises administering at least one selected from the group comprising (i) air flow, (ii) hot air flow, and (iii) air flow plus external heating onto the thinned biofilm layer for the predetermined active drying interval to disinfect the thinned biofilm layer. In another embodiment, administering at least one of air and a strong water absorbing material to actively dry the thinned biofilm layer further includes administering (iv) strong water absorbing materials, via a suitable reservoir (not shown) located with the active dryer 68 via the second channel 72b, to the at least one orifice 82, onto the thinned biofilm layer for the predetermined active drying interval of the thinned biofilm layer. Examples of strong water absorbing material(s) include one or more of: Calcium chloride (CaCl₂); zinc chloride (ZnCl₂); cellulose fibers; silica gel; borax; and polyacrylate/polyacrylamide copolymer. The device 50 further includes, in another embodiment, wherein the air flow, from active dryer 68, comprises a plurality of air pulses, and further wherein the hot air flow comprises a plurality of warm air pulses having a temperature greater than a threshold temperature.

In yet other embodiments, with reference to FIGS. 4 and 5, the microburst pump 66 may be disposed to provide both liquid sprays and the actively heated air. In this embodiment, air source 88 may provide source air to the pump 66 as it functions to drive air, without liquid through the at least one orifice 82. Control electronics 64 control the feed of liquid, air and heating energy into the stream in this embodiment. A single channel 72 (FIG. 4) can be used to deliver both liquid sprays and air to the at least one orifice 82. One advantage of this embodiment is that several elements, including the pump, air source, and channel, can provide both liquid spray flow and drying air flow in a sequence of liquid and air pulses. Thus, expense and complexity is reduced.

With reference now to FIGS. 6 (6(A), 6(B), 6(C), 6(D), 6(E), and 6(F)), side cross-sectional views and sectional views of first, second, and third alternate embodiments of a device having more than one channel and more than one orifice in a nozzle of the device for disinfection of a biofilm layer is shown, according to additional embodiments of the present disclosure.

With reference to FIGS. 6(A) and 6(B), the first channel 72a and the second channel 72b merge (indicated by reference numeral 71) into a single channel 75 coupled to a singular orifice 82. Suitable in-line check valves (i.e., one-way valves), 731 and 741, can be included within the configuration of FIG. 6(A) to prevent any undesired reverse flow in either the first channel 72a or the second channel 72b.

With reference to FIGS. 6(C) and 6(D), in one embodiment, the first channel 72a and the second channel 72b are coupled to separate distinct orifices 82a and 82b, respectively. As illustrated, orifices 82a and 82b are spaced laterally from one another. With reference to FIGS. 6(E) and 6(F), in another embodiment, the first channel 72a and the second channel 72b are coupled to separate distinct orifices 82a and 82b, respectively. As illustrated, orifices 82a and 82b are arranged in a coaxial configuration, with the first orifice 82a being positioned in a central location and the second orifice 82b being positioned around the central location. Accordingly, device 50 further includes wherein the separate distinct orifices comprise one selected from the group consisting of (a) orifices spaced laterally from one another and (b) orifices arranged in a coaxial configuration, with one of the first or second orifices being positioned in a central location and the other of the first or second orifices being positioned around the central location.

Although only a few exemplary embodiments have been described in detail above, those skilled in the art will readily appreciate that many modifications are possible in the exemplary embodiments without materially departing from the novel teachings and advantages of the embodiments of the present disclosure. For example, the embodiments of the present disclosure can be advantageously used in power toothbrush applications, oral hygiene devices, personal care devices with biofilm issues (e.g., facial cleaning), and medical devices with biofilm issues. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

In addition, any reference signs placed in parentheses in one or more claims shall not be construed as limiting the claims. The word “comprising” and “comprises,” and the like, does not exclude the presence of elements or steps other than those listed in any claim or the specification as a whole. The singular reference of an element does not exclude the plural references of such elements and vice-versa. One or more of the embodiments may be implemented by means of hardware comprising several distinct elements, and/or by means of a suitably programmed computer. In a device claim enumerating several means, several of these means may be embodied by one and the same item of hardware. The mere fact that certain measures are recited in mutually different dependent claims does not indicate that a combination of these measures cannot be used to an advantage.

1. A method for operating of a biofilm removal device, the method comprising:
operating a microburst pump to pump a fluid via a first channel to a first orifice directed at a biofilm layer, to thin the biofilm layer from an initial thickness to produce a thinned biofilm layer, wherein the first orifice expels the fluid as at least one of a jet or a spray; and
subsequently, operating an active dryer to actively dry the thinned biofilm layer, via the first or a second channel to the first or a second orifice directed at the thinned biofilm layer, for a predetermined active drying interval to disinfect the thinned biofilm layer.

2. The method of claim 1, wherein the thinned biofilm layer comprises a thickness of less than twenty micrometers.

3. The method of claim 1, wherein the predetermined active drying interval comprises a time interval less than two seconds.

4. The method of claim 3, further wherein the predetermined active drying interval further comprises a time interval less than one second.

5. The method of claim 1, wherein actively drying the thinned biofilm layer comprises administering, via the first or second channel to the first or second orifice bat least one selected from the group comprising (i) air flow, (ii) hot air flow, (iii) air flow plus external heating, and (iv) strong water absorbing materials.

6. The method of claim 5, further wherein the air flow comprises a plurality of air pulses, and further wherein the hot air flow comprises a plurality of warm air pulses having a temperature greater than a threshold temperature.

7. The method of claim 1, wherein pumping the fluid comprises pumping via a microburst pump.

8. The method of claim 7, wherein actively drying comprises pumping air via the microburst pump.

9. The method of claim 1, wherein there is a singular channel connected to a singular orifice for both pumping fluid and actively drying.

10. The method of claim 1, wherein the first channel and the second channel merge into a single channel coupled to the singular orifice.

11. The method of claim 1, wherein the first and second orifices comprise one selected from the group consisting of (a) orifices spaced laterally from one another and (b) orifices arranged in a coaxial configuration, with the first orifice being positioned in a central location and the second orifice being positioned around the central location.

12. A device for disinfection of a biofilm layer configured for use with a nozzle having at least one channel therein extending from a proximal end to at least one orifice at a distal end thereof, the device comprising:
a handle having a proximal end and a distal end, wherein the proximal end of the nozzle removably couples to the distal end of the handle; an activation button operable between an OFF state and at least one activation ON state; a fluid reservoir for holding a fluid; a microburst pump coupled between the fluid reservoir and a first at least one channel, an active dryer coupled to the first at least one channel or a second at least one channel,
wherein responsive to disposing the activation button to the at least one activation ON state, the microburst pump is operable to pump the fluid via the first at least one channel to a first at least one orifice and expel the fluid as at least one of a jet or a spray, to thin the biofilm layer, and, subsequent to the microburst pump pumping fluid, the active dryer administering at least one of air and a strong water absorbing material via the first at least one channel to the first at least one orifice or the second at least one channel to a second at least one orifice, to actively dry the thinned biofilm layer for a predetermined active drying interval to disinfect the thinned biofilm layer.
